(19) United States
(12) Patent Application Publication
(10) Pub. No.: US 2022/0339741 A1
(43) Pub. Date: Oct. 27, 2022

(54) METHOD OF LASER BEAM MACHINING OF A TRANSPARENT BRITTLE MATERIAL AND DEVICE EMBODYING SUCH METHOD

(71) Applicants: IRE-POLUS, Fryazino (RU); IPG PHOTONICS CORPORATION, Oxford, MA (US); IPG LASER GmbH, Burbach (DE)

(72) Inventors: Timoor ALIEV, Fryazino (RU); Nikolai EVTIKHIEV, Fryazino (RU); Mikhail KAPTAKOV, Fryazino (RU); Ivan OBRONOV, Fryazino (RU)

(73) Assignees: IRE-POLUS, Fryazino (RU); IPG PHOTONICS CORPORATION, Oxford, MA (US); IPG LASER GmbH, Burbach (DE)

(21) Appl. No.: 17/640,964

(22) PCT Filed: Mar. 27, 2020
(86) PCT No.: PCT/EP20/58826

§ 371 Date: Mar. 7, 2022

(30) Foreign Application Priority Data
Sep. 6, 2019 (RU) RU2019128151

(51) Int. Cl. B23K 26/55; B23K 26/082; B23K 26/0622; B23K 26/06

(52) U.S. Cl. CPC B23K 26/55; B23K 26/082; B23K 26/0624; B23K 26/0643; B23K 26/0648; B23K 2103/54

(57) ABSTRACT

The invention relates to laser equipment, specifically pulsed scanning lasers used to cut brittle substrates. The authors propose a method and device for forming a stressed edge in the substrate for cleaving of the substrate, to which end a track of cavities is formed through optically induced breakdown in the body of tire material during its irradiation with a focused laser beam with a fixed focal distance during the course of angled scanning of the laser beam, with longitudinal movement along the length of the substrate. The technical result is: improved strength parameters of products and better quality of straight and oblique edges formed during substrate cleaving, absence of chips and microcracks, high rate of formation of the stressed cleaving edge, which implies faster laser cutting.

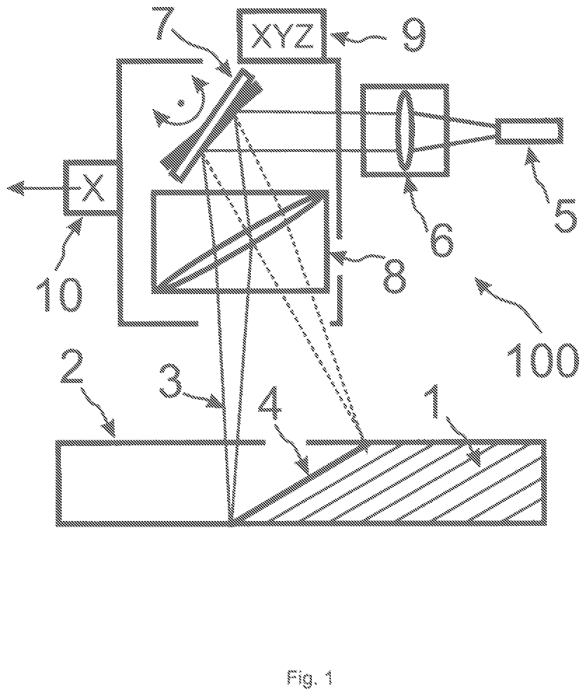

### FIELD OF THE INVENTION

The invention relates to the field of laser technique, specifically to pulsed scanning lasers used to cut brittle substrates.

### BACKGROUND OF THE INVENTION

Pulsed lasers are widely used in semiconductor industry for scribing of thin, up to 1 mm, substrates made of silicon, germanium, gallium arsenide and other semiconductors as well as ceramic and glass substrates. Prior art describes various methods of forming the cleave line, ranging from the V-shaped groove during laser scribing to ablation or melting of the material on its top or bottom surfaces (US20190169062A1). However, after this operation there is a need either to apply a mechanical force to the laser-treated material or to create a thermally deforming wave by heating (or local cooling) the material. Either of these actions does not always have a favourable outcome—cleaving without chips, microcracks and defects.

Femto- and pico-second lasers are used to prepare substrates, including thick substrates made of glass, for cleaving. Prior art (U.S. Ser. No. 10/233,112B2) describes a method of perforation of thin glass substrates used as smartphone and display screens using a pico-second laser by perforating the glass and subsequently heating the perforation line with a second laser—a high power CO₂ laser—to induce a crack and cleave the glass. This method is not applicable to thick glass. Meanwhile, the use of the additional high power laser complicates the process. Such cutting problems arise during machining of thick shop window glass panes, laminated and tempered car windows, glass with a protective coating and armoured glass.

Prior art teaches a method of glass cutting by creating a grid of filaments (tracks) as a result of laser beam self-focusing due to the presence of nonlinear effects in glass. During beam filamentation, a hollow track of several hundred micrometers long is created in the body of the substrate (RU2013102422A or in the international publication, WO2012006736A2, as well as in U.S. Pat. No. 9,757,815B2), thereby making it possible to create a series of tracks, including near the back surface, to prepare the substrate for cleaving. The filamentation method also imposes limitations on the cutting of thick glass: it cannot be applied glass having the thickness of 6 mm or greater due to the geometry of the optics (this requires a micro-lens with a short focal distance or dedicated optics that can ensure a long focus and an interference pattern within the glass body—a Bessel beam). The laser beam waist has to be formed deeper into the substrate's body in order to eliminate breakdown in the near-surface region. In light of the fact that the array of tracks is not continuous, certain fundamental limitations apply during its formation: during focusing and self-focusing there must not be any boundary interference from nearby irregularities and filaments. Limitations with respect to the glass thickness also apply: there is a need for multi-pass scanning along the surface of the substrate in order to fill the substrate body with filaments that are far apart from each other (due to the conditions of their formation), which imposes a limitation on the accuracy of alignment of arrays of filament grids. Contour precision should be at least 4 micrometers. This method calls for using a complex and high-precision system for tracking the movement trajectory and repeatability of trajectories; during multi-pass cutting, this adversely affects the cutting quality and may result in chips during unavoidable final splitting of the glass substrate after cutting using the filamentation method. All of this makes it impossible to cleave the material without applying a mechanical force and imposes limitations on the industrial applicability of the method.

### DISCLOSURE OF THE INVENTION

The present invention proposes a method for cleaving brittle materials of the substrate that are transparent to the laser beam and do not absorb it too much, along a practically continuous stressed edge in the body of the substrate formed as a result of laser-induced breakdown of the material. The effect of the method can be readily illustrated using the example of cutting of thick glass having a thickness of 20 mm or greater—up to 30 mm. This cleaving, substantially continuous stressed edge consists of micro-cavities. The latter are formed as a result of the induced breakdown which in turn is caused by the laser beam focused in the body of the substrate. The laser beam strikes the surface of the body at an angle while it moves progressively along the surface. Simultaneously with the progressive movement, the beam is continuously and rapidly oscillating in the same plane in which it is moving progressively. This ensures continuous scanning of the entire substrate section by the beam. The method is not sensitive to the direction of beam movement in the substrate section from the upper or bottom surface of the substrate. Importantly, the focused laser beam cyclically penetrates the entire thickness of the substrate body, which is particularly important considering the once-chosen long-focal (150-350 mm) distance of the lens of the optical system, which remains unchanged through the entire process of forming the stressed edge for cleaving the substrate upon its completion.

The technical result is better quality of straight, curvilinear or angled edge of cleaving of the substrate in the absence of uncontrollable chips and microcracks, a high rate of formation of the stressed cleaving edge, which implies faster laser cutting, owing to the absence of:
reconfiguration of the optical system to focus the laser beam during its scanning across the entire depth of the substrate body,
process interruptions to reconfigure the depth of formation of the layer of the stressed edge within the substrate body, irrespective of the direction of beam movement from the upper or bottom surface of the substrate,
   and owing to the presence of the maximum possible number of optically induced breakdown cavities in the body of the substrate material during progressive continuous movement of the scanning system along the length of the substrate, which generally improves the strength properties of products made of substrates cleaved using the proposed method.

The displacement of the beam and substrate relative to one another is not only limited to a linear or curvilinear path. The scope of the invention includes rotational displacement of the beam and substrate relative one another which in combination with the linear displacement produces holes in the substrate. Furthermore, as disclosed above, the inventive system may produce angled or curved edges. If the treated substrate is not fully split, a thulium (Tm) laser, preferably, but not necessarily, a Tm fiber laser can be used to provide a final “touch” leading to the separation of the cut substrate pieces with respective smooth edges.

Other advantages and distinctive features of the proposed invention will become obvious from the following detailed description of its essence, with references to the accompanying drawings.

### BRIEF DESCRIPTION OF THE FIGURES

Sole FIGURE is a schematic diagram of the process of forming the stressed cleaving edge in the body of the substrate with the laser beam positioned at an angle, frontal view.

### EMBODIMENTS OF THE INVENTION

The essence of the claimed invention is reflected in the following features and details.

The general details of the invention are illustrated by the FIGURE and relate to the inventive method and the device (100) that embodies it. To provide a stressed edge (1) in a substrate (2) made of a material transparent to a laser beam, a focused laser beam with a fixed focal distance is incident thereon during the course of angled scanning of the beam. As the beam and substrates (2) linearly move relative to one another, a track of cavities is formed in the substrate body through local optically induced breakdown of the material during its irradiation. As the beam irradiates the substrate in the above-disclosed manner, the following takes place:
an essentially linear chain (4) of narrowly spaced cavities (at least one cavity per each pulse) is formed in the body of the material in a single pass of the beam (3) in the direction from one surface of the substrate to the opposite surface, and
during the other (consecutive) pass of the beam, relative progressive longitudinal movement of the beam and the substrate results in the formation of the next narrowly-spaced chain of cavities.

The end result of the progressive longitudinal movement and angled cyclical scanning of the beam in the plane of this movement is an essentially continuous track of optically induced cavities in the form of the internal bubbly stressed edge (1) along which the substrate is cleaved without chipping defects upon completion of the process of longitudinal movement of the beam along the entire length of the substrate (2).

The device implementing the above disclosed inventive method is configured with a pulsed laser source (5). The latter may be selected from a solid-state laser or a fibre laser. The emitted laser beam is collimated in a collimator (6) and thereafter it strikes a beam deflection system or scanner (7). The scanner (7) ensures cyclical scanning of the beam through the thickness of the substrate from top surface to the opposite surface or conversely since the direction—direct or reverse—is irrelevant). An optical focusing system (8) ensures beam focusing and has a setting that does not change throughout the entire machining process. During this process, the angle of incidence of the laser beam onto the surface varies from 90° to about 40.5° depending on the desired shape of the cleave relative to the normal to the surface of the substrate For example, this angle can be slightly less than 60 degrees when forming a straight cleave. If the cleave is oblique or bevelled, smaller angles of incidence of up to 45° are required. Note that as the angle of incidence increases, light losses also increase due to deflection at higher angles. It has been determined that the angle at which the cut is formed relative to the surface of the substrate should be preferably limited to a 45-90° range. The desired angle is set by the beam spatial orientation system (9) along the spatial axes XYZ relative to the surface of the substrate. The longitudinal progressive movement of the beam (3) along the surface of the substrate (2) is ensured by the actuator (10) responsible for its unidirectional progressive movement along axis X over a fixed substrate with a lead ahead of the region in which the stressed edge forms. Note that the scanner (7) and the optical focusing system (8) may be positioned also at another angle relative to the surface of the workpiece comparing to what is shown in the FIGURE.

It is important to note that the deflection system (7), which scans in one plane and is uniaxial at a minimum, for high-speed scanning of the beam (3) in the transverse direction relative to the substrate (2) can be implemented on the basis of both a galvano scanner and a polygon, the latter being the preferred solution because the polygon ensures uniform distribution of optically induced breakdown cavities.

Notably, the stressed edge (up to 30 mm thick) essentially forms across the entire body of the thick substrate with the distance between optically induced breakdown cavities in the micrometer range, which is determined by the dimensions of cavities and the rates of scanning in both the transverse angled direction and the longitudinal direction.

Notably, optically induced breakdown is achieved by a pulsed femto- or pico- or nano-second focused laser beam source with a sufficient pulse energy for optically induced breakdown of the material, with a wavelength in the range from ultraviolet to infrared waves, but on condition of their weak absorption in the material being machined.

Importantly, a material transparent to a laser beam can contain one or more layers and be chosen from glass, quartz, semiconductor, dielectric, polymer material, crystal, sapphire, and/or diamond-like films. In engineering, the substrate made of a transparent material is chosen for purposes of creating information display devices—flat screens or TV screens, or for cutting of window panes, mirrors, laminated car window glass, armoured window glass, or transparent ceramics.

This invention has been successfully tested in cutting of glass 4 to 20 mm thick, including laminated glass, with the use of the YLPP-50-10-100-R pico-second fibre ytterbium laser (IRE-Polys, https://www.ipgphotonics.com/ru_).

The pulse length is 10-20 ps; the pulse energy is up to 100 μJ; and the pulse repetition rate is up to 2 MHz. Glass 20 mm thick has been cut using a scanning system based on a galvano scanner; the beam incidence angle is 40.5 degrees; the deflection angle is ±4.5 degrees; the focal distance of the focusing system based on an F-Theta lens is 260 mm; the coefficient of reflection from the glass surface is in the range of 4.6 to 5.2%; and the rate of longitudinal movement is up to 40 mm/s. However, other configurations or modifications of the above-mentioned setup, especially with regard to wavelength, pulse energy, pulse repetition rate and/or pulse duration, can be also be chosen by a person skilled in the art, for example as described in the U.S. Pat. No. 9,296,066 or 10,399,184.

The laser beam and substrate can rotate relative to one another to drill holes in the substrate. Furthermore, the disclosed system can produce curved edges. If the treated substrate is not fully cleaved, a thulium (Tm) laser, preferably, but not necessarily, a Tm fiber laser can be used to provide a final “touch” leading to the separation of the cut substrate pieces with respective smooth edges.

It should be obvious to a person skilled in this field of engineering that the invention is not limited to the embodiment options presented above and that it can be modified within the scope of the claims of the presented invention. The distinctive features presented in the description along with other distinctive features can be also used separately from one another, if necessary.

1. A method for forming a stressed edge for cleaving of a substrate made of a material transparent to a laser beam, to which end a track of cavities is formed in the body of the substrate through local optically induced breakdown of the material during its irradiation with a focused laser beam with a fixed focal distance during the course of angled scanning of the laser beam, with longitudinal movement along the length of the substrate, whereby:
an essentially angular linear chain of narrowly spaced cavities (at least one cavity per each pulse) is formed in the body of the material in a single pass of the beam in the direction from one surface of the substrate to the opposite surface, and
during other pass of the beam, relative progressive longitudinal movement of the beam and the substrate results in the formation of the next narrowly-spaced chain of cavities, and the end result of this process of progressive longitudinal movement and angled cyclical scanning of the beam in the same plane is an essentially continuous track of optically induced cavities in the form of an internal bubbly stressed edge along which the substrate is cleaved without chipping defects.

2. Method of claim 1, whereby the other pass of the beam is a reverse or returning pass of the beam during progressive longitudinal movement of the beam, which is carried out continuously in the same direction over a substrate fixed in place, with a lead relative to the region in which the stressed edge is being formed.

3. Method of one of the above claims, whereby the track of the stressed edge essentially forms across the entire body of the substrate with the distance between optically induced breakdown cavities in the micrometer range, which is determined by the dimensions of cavities as well as the rates of scanning both in the transverse angled direction and in the longitudinal direction.

4. Method of one of the above claims, whereby the plane in which the cleaving edge is formed is orthogonal relative to the surface or tilted at an angle of at least 45 degrees to form an oblique cleaving edge.+

5. Method of one of the above claims, whereby a pulsed femto- or pico- or nano-second focused laser beam source is used with a sufficient pulse energy for optically induced breakdown of the material, and wherein the laser beam source is based on a solid-state or fibre laser.

6. Method of one of the above claims, whereby a material transparent to the laser beam contains one or more layers of materials chosen from the following series: glass, quartz, semiconductor, dielectric, polymer material, crystal, sapphire, diamond-like films.

7. Method of claim 6, whereby the substrate made of a transparent material is chosen for purposes of creating information display devices, especially flat screens or TV screens, or for cutting of window panes, mirrors, laminated car windows, armoured glass, or transparent ceramics.

8. A device that forms a stressed edge in the given plane within the body of the transparent material to be cleaved using the above method, containing:
a source of pulsed laser light with a collimated beam emitter,
a system for beam orientation in space relative to the substrate surface,
an angular scanning system for high-speed beam scanning in a single plane, in the transverse direction relative to the substrate,
an actuator for monodirectional progressive movement of the angled beam along the surface of the substrate,
an optical focusing system.

9. Device of claim 8, in which the optical focusing system does not change the beam focus when a stressed edge up to 30 mm thick is being formed.

10. Device of one of the claim 8 or 9, in which the angle of incidence of the beam relative to the surface normal during creation of the stressed edge can be less than 60 degrees in the orthogonal plane (to form a straight face) or be in any other angled plane at an angle of up to 45 degrees (to form an oblique face).
